(19) United States
(12) Patent Application Publication
(10) Pub. No.: US 2013/0197739 A1
(43) Pub. Date: Aug. 1, 2013

(54) METHODS AND SYSTEMS FOR AIRCRAFT HEALTH AND TREND MONITORING

(71) Applicants: James Gallagher, Savannah, GA (US); Robert O'Dell, Rincon, GA (US)

(72) Inventors: James Gallagher, Savannah, GA (US); Robert O'Dell, Rincon, GA (US)

(73) Assignee: GULFSTREAM AEROSPACE CORPORATION, Savannah, GA (US)

(21) Appl. No.: 13/362,918

(22) Filed: Jan. 31, 2012

(51) Int. Cl. B64F 5/00

(52) U.S. Cl. 701/31.5

(57) ABSTRACT

The disclosed embodiments relate to methods and systems for monitoring sub-systems of an aircraft to detect an abnormal condition, and for identifying one or more sources that are causing the abnormal condition. In response to detecting a trigger event during flight of the aircraft, data for a plurality of relevant parameters is measured and stored in a parameter file. The parameter file is transmitted from the aircraft over a wireless communication link, and relayed to a ground support network. At the ground support network, the measured data for the plurality of the relevant parameters is then used to identify the one or more sources that are causing the abnormal condition.

### TECHNICAL FIELD

Embodiments of the present invention generally relate to aircraft, and more particularly relate to methods and systems for monitoring an aircraft.

### BACKGROUND OF THE INVENTION

Modern aircraft are often equipped with sophisticated systems, such as flight data recorders, which report information and store in-flight data. In addition, ground-based systems support aircraft maintenance.

When an aircraft is in flight, it can be difficult to detect when sub-systems or components of an aircraft begin to operate abnormally, and/or to correctly diagnose the specific source that is causing that sub-system or component to operate abnormally. While these abnormal operating conditions may persist after the aircraft has landed, in many cases that is not true, which can make it even more difficult to correctly diagnose the specific source that is causing that sub-system or component to operate abnormally.

There is a need for methods and systems for monitoring the health of an aircraft and the aircraft's various components and sub-systems. It would be desirable to provide methods and systems that can automatically detect abnormal conditions that indicate when one or more sub-systems or components of an aircraft have experienced a degradation in performance. It would also be desirable if such methods and systems can identify the specific source(s) within those particular sub-systems or components that are causing the degradation in performance so that corrective actions can be taken with respect to the identified sub-systems or components prior to fault or failure. It would also be desirable if such methods and systems execute automatically and do not require crew intervention. Furthermore, other desirable features and characteristics of the present invention will become apparent from the subsequent detailed description and the appended claims, taken in conjunction with the accompanying drawings and the foregoing technical field and background.

### SUMMARY

In one embodiment, a method is provided for monitoring sub-systems of an aircraft to detect an abnormal condition, and then for identifying one or more sources that are causing the abnormal condition. In response to detecting a trigger event during flight of the aircraft, data for a plurality of relevant parameters is measured, and stored in a parameter file that is transmitted from the aircraft over a wireless communication link. The parameter file is then relayed to a ground support network, and the measured data for the plurality of the relevant parameters is then used at the ground support network to identify the one or more sources that are causing the abnormal condition.

In another embodiment, a system is provided. The system includes at least an aircraft and a ground support network that is designed to identify one or more sources on the aircraft that are causing an abnormal condition. The aircraft has a plurality of sub-systems, a first processor, a first memory and a transmitter. The first processor can monitor the sub-systems to detect a trigger event during flight of the aircraft. The first processor can then measure, in response to detecting the trigger event, data for a plurality of relevant parameters, and store measured data for each of the relevant parameters in a parameter file at the first memory. The transmitter can then transmit the parameter file from the aircraft over a wireless communication link. The parameter file is eventually relayed to the ground support network. The second memory can be configured to store a plurality of aircraft health and trend monitoring (AHTM) program modules. The second processor configured to execute a selected one of the AHTM program modules and to process the measured data for the plurality of the relevant parameters to identify the one or more sources that are causing the abnormal condition.

### DESCRIPTION OF THE DRAWINGS

Embodiments of the present invention will hereinafter be described in conjunction with the following drawing figures, wherein like numerals denote like elements, and

FIG. 1 is an integrated system for aircraft health and trend monitoring of an aircraft and the aircraft's various sub-systems in accordance with some of the disclosed embodiments.

FIG. 2A is a perspective view of an aircraft that can be used in accordance with some of the disclosed embodiments.

FIG. 2B is a block diagram of an Aircraft Health and Trend Monitoring system in accordance with an exemplary implementation of the disclosed embodiments.

FIG. 2C is a block diagram of some of an aircraft's various sub-systems in accordance with an exemplary implementation of the disclosed embodiments.

FIG. 3 is a block diagram of portions of a ground support network in accordance with one exemplary implementation of the disclosed embodiments.

FIG. 4 is a flowchart of a method for monitoring health and trending of an aircraft's various sub-systems in accordance with some of the disclosed embodiments.

FIG. 5 is a flowchart of another method for monitoring health and trending of an aircraft's various sub-systems in accordance with some of the other disclosed embodiments.

### DESCRIPTION OF EXEMPLARY EMBODIMENTS

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary or the following detailed description.

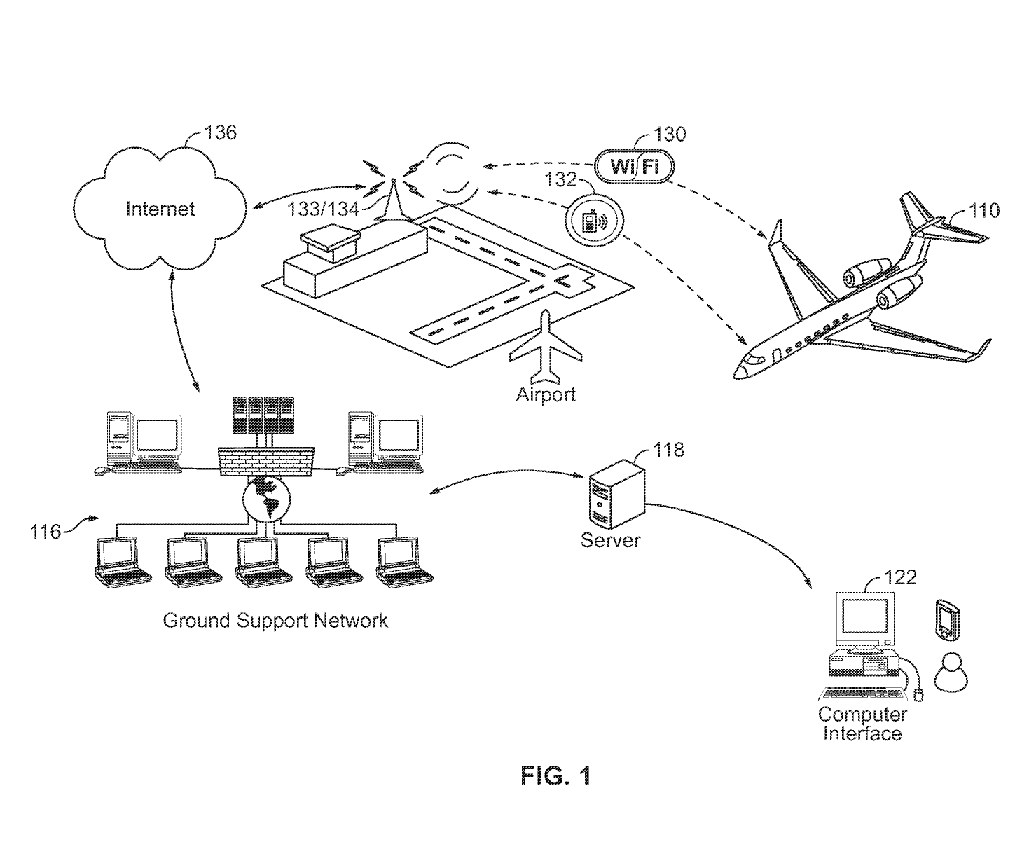

FIG. 1 is an integrated system 100 for health and trend monitoring of an aircraft 110 and the aircraft's various sub-systems in accordance with some of the disclosed embodiments. As used herein, the term “health monitoring” refers to the process of collecting and evaluating relevant parameters and/or measured data to determine the state, status, or numerical output value of a component and/or sub-system in any given time period. As used herein, the term “trend monitoring” refers to the process of collecting and evaluating relevant parameters and/or measured data to determine the state, status, or numerical output value of a component and/or sub-system in any given time period in order to predict, estimate, or trend, said state, status, or numerical output value of a component and/or sub-system at a future time.

The system includes a aircraft 110, a WLAN access point 133, a cellular base station 134, a ground support network (GSN) 116, a server 118 and a computer interface 122 located at aircraft monitoring center of either an operator or the aircraft manufacturer.

In response to various trigger events or Crew Alerting System (CAS) messages, the aircraft 110 generates and communicates parameter files to the WLAN access point 133 via a WLAN communication link 130 or to a cellular base station 134 via a cellular communication link 132. The information stored in the parameter files can include measured data for relevant variables, CAS messages, and measured data for relevant parameters associated with each of the relevant variables and CAS messages. The WLAN access point 133 or the cellular base station 134 communicates the parameter files via a wired link over the Internet 136 to the ground support network 116. The ground support network 116 is coupled to the server 118 via a communication link.

The ground support network 116 is operated by a third party. The ground support network 116 includes several health management algorithms that are used to process data included in the parameter files. Once the data from the parameter files is processed using the appropriate health management algorithms, the ground support network 116 generates web pages that are provided to the server 118. The web pages include information regarding aircraft health and/or fleet health. The web pages can include information stored in parameter files that are communicated from the aircraft 110 to the ground support network 116. The web pages can also include information stored in inspection files generated at the ground support network 116 as well as information that identifies elements of the aircraft, such as sub-systems (or components thereof), which need to be inspected.

The server 118 serves the web pages from the ground support network 116 to a computer that is coupled to the computer interface 122 so that the web pages can be displayed.

The computer interface 122 allows communication to the ground support network 116, for example from a system operator and/or another computer system, and can be implemented using any suitable method and apparatus. This way, the information generated at the ground support network 116 can be viewed by personnel at a monitoring station on the computer interface 122 by an operator. The computer interface 122 can include one or more network interfaces to communicate to other systems or components, one or more terminal interfaces to communicate with technicians, and one or more interfaces to connect to the processor 116-1 or memory 116-2 of the ground support network 116.

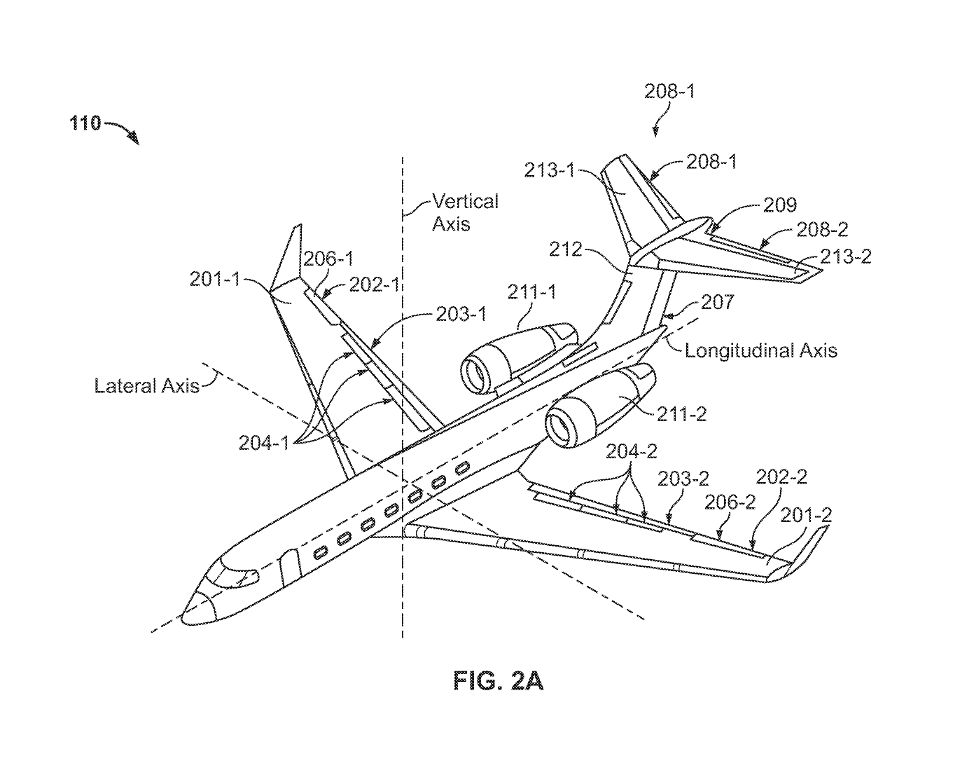

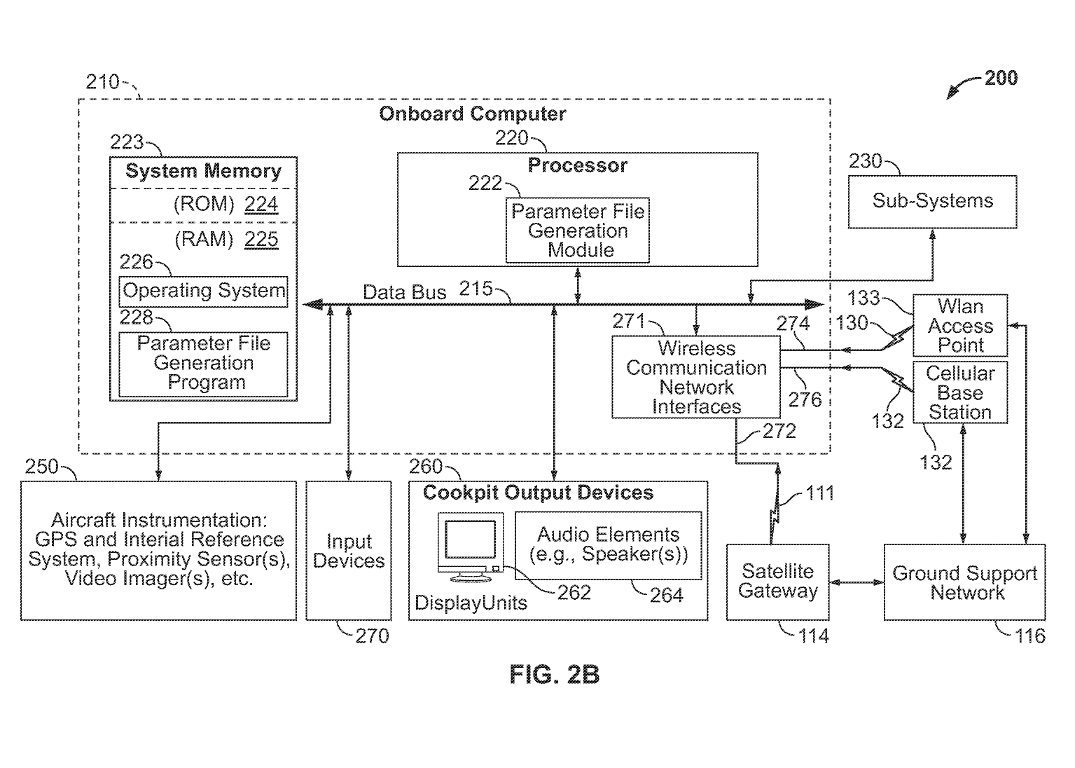

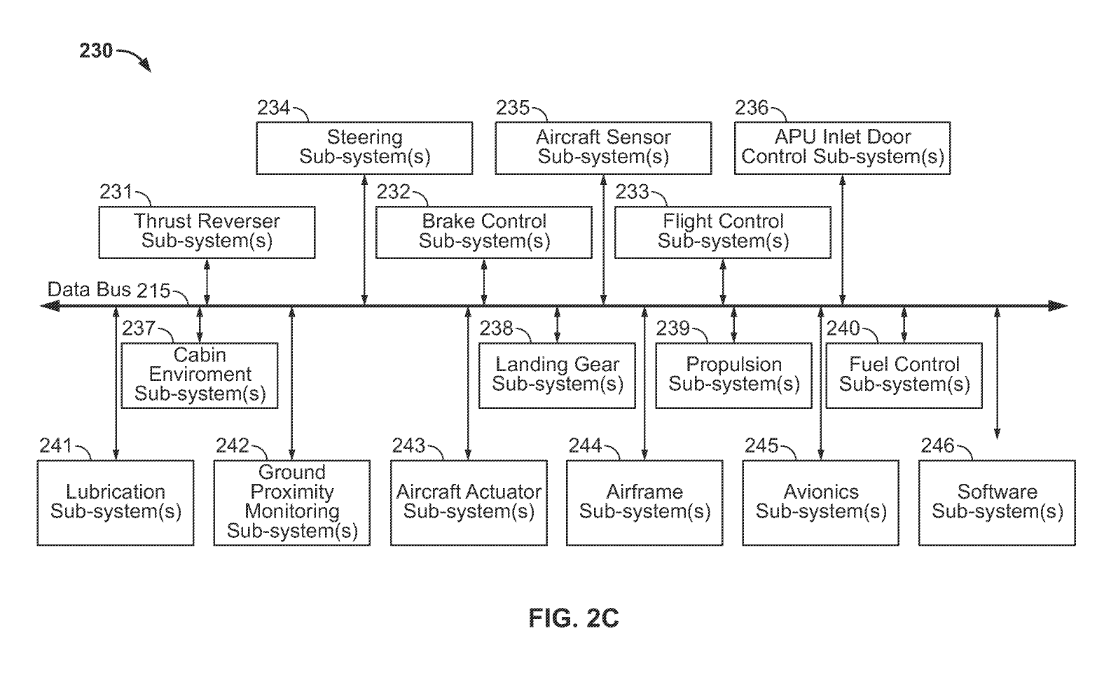

FIG. 2A is a perspective view of an aircraft 110 that can be used in accordance with some of the disclosed embodiments. In accordance with one non-limiting implementation of the disclosed embodiments, the aircraft 110 includes a fuselage, two main wings 201-1, 201-2, a vertical stabilizer 212, an elevator 209 that includes two horizontal stabilizers 213-1 and 213-2 in a T-tail stabilizer configuration, and two jet engines 211-1, 211-2. For flight control, the two main wings 201-1, 201-2 each have an aileron 202-1, 202-2, an aileron trim tab 206-1, 206-2, a spoiler 204-1, 204-2 and a flap 203-1, 203-2, the vertical stabilizer 212 includes a rudder 207, and the aircraft's horizontal stabilizers (or tail) 213-1, 213-2 each include an elevator trim tab 208-1, 208-2. Although not shown in FIG. 1, the aircraft 110 also includes an onboard computer, aircraft instrumentation and various control systems as will now be described with reference to FIG. 2B.

FIG. 2B is a block diagram of an Aircraft Health and Trend Monitoring (AHTM) system 200 in accordance with an exemplary implementation of the disclosed embodiments. Part of the system 200 is implemented within an aircraft 110 for acquiring data. This data can include measured data for one or more relevant variables, measured data for relevant parameters associated with the one or more relevant variables, CAS messages and measured data for relevant parameters associated with the one or more CAS messages. This data can then be communicated from the aircraft 110 to the ground support network 116 and used for monitoring the health of one or more elements (e.g., sub-systems 230 or components of such sub-systems) of the aircraft 110, and/or for monitoring trending behavior exhibited by one ore more elements of the aircraft 110. As shown, the system 200 includes various sub-systems 230 of the aircraft 110.

The aircraft 110 portion of the system 200 includes an onboard computer 210, various sub-systems 230, aircraft instrumentation 250, cockpit output devices 260 (e.g., display units 262 such as control display units, multifunction displays (MFDs), etc., audio elements 264, such as speakers, etc.), and various input devices 270 such as a keypad which includes a cursor controlled device, and one or more touchscreen input devices which can be implemented as part of the display units.

The aircraft instrumentation 250 can include, for example, the elements of a Global Position System (GPS), which provides GPS information regarding the position and speed of the aircraft, and elements of an Inertial Reference System (IRS), proximity sensors, switches, relays, video imagers, etc. In general, the IRS is a self-contained navigation system that includes inertial detectors, such as accelerometers, and rotation sensors (e.g., gyroscopes) to automatically and continuously calculate the aircraft's position, orientation, heading and velocity (direction and speed of movement) without the need for external references once it has been initialized.

The cockpit output devices 260 can include display units 262 and audio elements 264. The display units 262 can be implemented using any man-machine interface, including but not limited to a screen, a display or other user interface (UI). The audio elements 264 can include speakers and circuitry for driving the speakers.

The input devices 270 can generally include, for example, any switch, selection button, keypad, keyboard, pointing devices (such as a cursor controlled device or mouse) and/or touch-based input devices including touch screen display(s) which include selection buttons that can be selected using a finger, pen, stylus, etc.

The onboard computer 210 includes a data bus 215, a processor 220, system memory 223, and wireless communication network interfaces 271.

The data bus 215 serves to transmit programs, data, status and other information or signals between the various elements of FIG. 2B. The data bus 215 is used to carry information communicated between the processor 220, the system memory 223, the various sub-systems 230, aircraft instrumentation 250, cockpit output devices 260, various input devices 270, and wireless communication network interfaces 271. The data bus 215 can be implemented using any suitable physical or logical means of connecting the on-board computer 210 to at least the external and internal elements mentioned above. This includes, but is not limited to, direct hard-wired connections, fiber optics, and infrared and wireless bus technologies.

The processor 220 performs the computation and control functions of the computer system 210, and may comprise any type of processor 220 or multiple processors 220, single integrated circuits such as a microprocessor, or any suitable number of integrated circuit devices and/or circuit boards working in cooperation to accomplish the functions of a processing unit.

It should be understood that the system memory 223 may be a single type of memory component, or it may be composed of many different types of memory components. The system memory 223 can includes non-volatile memory (such as ROM 224, flash memory, etc.), volatile memory (such as RAM 225), or some combination of the two. The RAM 225 can be any type of suitable random access memory including the various types of dynamic random access memory (DRAM) such as SDRAM, the various types of static RAM (SRAM). The RAM 225 includes an operating system 226, and parameter file generation programs 228. The RAM 225 stores executable code for one or more parameter file generation programs 228. The parameter file generation programs 228 (stored in system memory 223) that can be loaded and executed at processor 220 to implement a parameter file generation module 222 at processor 220. As will be explained below, the processor 220 executes the parameter file generation programs 228 to generate parameter files that include measured data that is used at the ground support network 116 to conducting health and trend monitoring for one or more aircraft sub-systems (or components thereof).

In addition, it is noted that in some embodiments, the system memory 223 and the processor 220 may be distributed across several different on-board computers that collectively comprise the on-board computer system 210.

The wireless communication network interfaces 271 are operatively and communicatively coupled antennas 272, 274, 276 that are external to the on-board computer 210. The antennas include a satellite antenna 272 that can be used to communicate information with a satellite gateway 114 over a satellite communication link, a WLAN antenna 274 that can be used to communicate information with a WLAN access point 133 over a WLAN communication link, and a cellular network antenna 276 that can be used to communicate information to/from a cellular base station 134 over a cellular communication link. The satellite gateway 114, the WLAN access point 133, and the cellular base station 134 can all be coupled to other networks, including the Internet, so that information can be exchanged with remote computers.

FIG. 2C is a block diagram of various sub-systems 230 of an aircraft 110 in accordance with an exemplary implementation of the disclosed embodiments. In one exemplary, non-limiting implementation, the various sub-system(s) 231-246 include a thrust reverser control sub-system(s) 231, a brake control sub-system(s) 232, a flight control sub-system(s) 233, a steering control sub-system(s) 234, aircraft sensor control sub-system(s) 235, an APU inlet door control sub-system(s) 236, a cabin environment control sub-system(s) 237, a landing gear control sub-system(s) 238, propulsion sub-system(s) 239, fuel control sub-system(s) 240, lubrication sub-system(s) 241, ground proximity monitoring sub-system(s) 242, aircraft actuator sub-system(s) 243, airframe sub-system(s) 244, avionics sub-system(s) 245, software sub-system(s) 246. The sub-system(s) 230-246 that are illustrated in FIG. 2B are exemplary only, and in other embodiments various other sub-system(s) can be included such as, for example, air data sub-system(s), auto flight sub-system(s), engine/powerplant/ignition sub-system(s), electrical power sub-system(s), communications sub-system(s), fire protection sub-system(s), hydraulic power sub-system(s), ice and rain protection sub-system(s), navigation sub-system(s), oxygen sub-system(s), pneumatic sub-system(s), information sub-system(s), exhaust sub-system(s), etc.

Although not illustrated in FIG. 2C, those skilled in the art will appreciate that each of the various sub-systems can include one or more components. In addition, each of the various sub-systems can each include one or more sensors to facilitate measurement and generation of data pertaining to operation of that sub-system of the aircraft 110 (and/or a component of that sub-system), to assist in performing diagnostics and health monitoring of one or more sub-systems, etc. Each sensor can generate data that is used to generate information that can be included in the parameter files that are generated by the parameter file generation unit 222. In general, a “sensor” is a device that measures a physical quantity and converts it into a signal which can be read by an observer or by an instrument. In general, sensors can be used to sense light, motion, temperature, magnetic fields, gravitational forces, humidity, vibration, pressure, electrical fields, current, voltage, sound, and other physical aspects of an environment. Non-limiting examples of sensors can include acoustic sensors (e.g., sound, microphone, seismometer, accelerometer, etc.), vibration sensors, vehicle sensors (e.g., air speed indicator, altimeter, attitude indicator, gyroscope, inertial reference unit, magnetic compass, navigation instrument sensor, speed sensors, throttle position sensor, variable reluctance sensor, viscometer, wheel speed sensor, Yaw rate sensor, etc.), chemical sensors/detectors, electric current sensors, electric potential sensors, magnetic sensors, radio frequency sensors, environmental sensors, fluid flow sensors, position, angle, displacement, distance, speed, acceleration sensors (e.g., accelerometer, inclinometer, position sensor, rotary encoder, rotary/linear variable differential transformer, tachometer, etc.), optical, light, imaging sensors (e.g., charge-coupled device, infra-red sensor, LED, fiber optic sensors, photodiode, phototransistors, photoelectric sensor, etc.), pressure sensors and gauges, strain gauges, torque sensors, force sensors piezoelectric sensors, density sensors, level sensors, thermal, heat, temperature sensors (e.g., heat flux sensor, thermometer, resistance-based temperature detector, thermistor, thermocouple, etc.), proximity/presence sensors, etc.

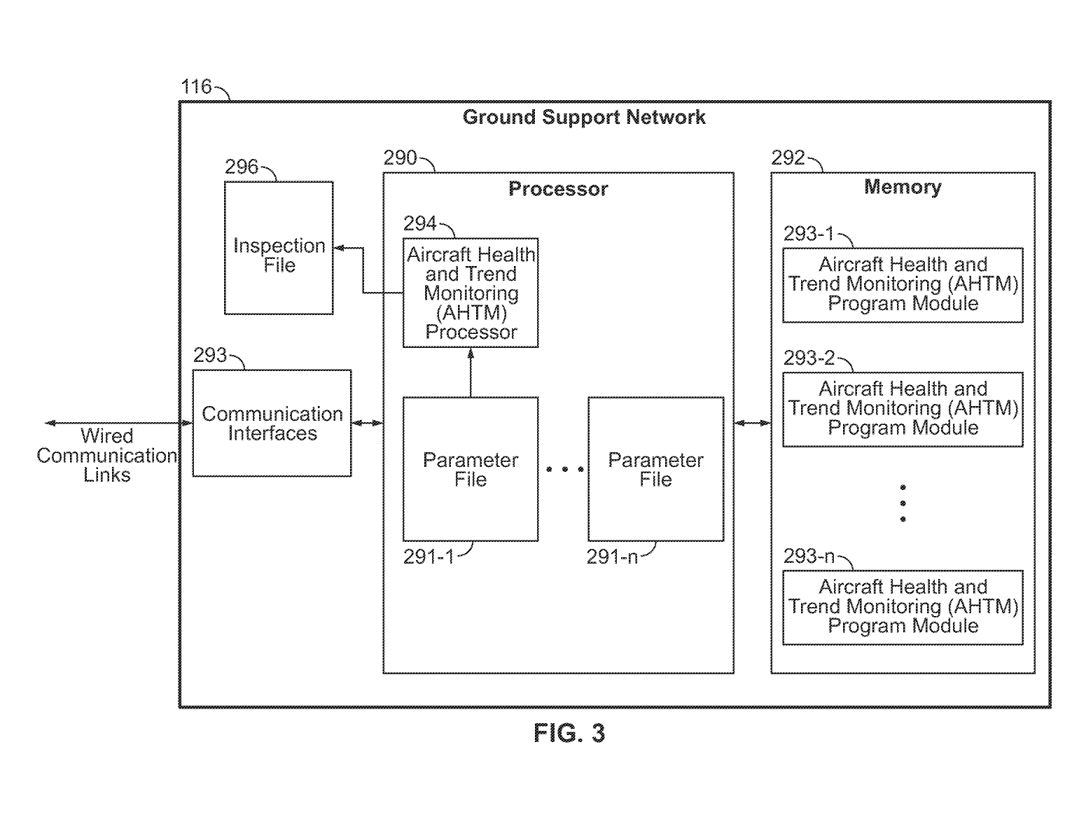

FIG. 3 is a block diagram of portions of a Ground support network (GSN) 116 in accordance with one exemplary implementation of the disclosed embodiments. As illustrated in FIG. 3, the ground support network 116 includes a processor 290, memory 292 and communication interfaces 293 that are coupled to various different wired communication links.

The memory 292 can be implemented using any of the memory technologies that are disclosed herein. The memory 292 stores a plurality of Aircraft Health and Trend Monitoring (AHTM) program modules 293-1 . . . 293-n. Each of the AHTM program modules 293 are programmed with computer executable instructions for implementing a particular health and trend monitoring algorithm (HTMA). The memory 292 can store various different AHTM program modules 293 that can be used to implement various different HTMAs via computer executable instructions.

When parameter files 291-1 . . . 291-n are received at the ground support network 116 from the aircraft 110, each parameter file 291 can be loaded at the processor 290 along with a corresponding AHTM program module 293 that corresponds to that particular type of parameter file. When the processor 290 executes the computer executable code of an AHTM program module 293 with respect to measured data included in one of the parameter files 291, an instantiation of an Aircraft Health and Trend Monitoring (AHTM) processor 294 is implemented at the processor 290.

Relevant Variable Embodiments

In accordance with some of the disclosed embodiments, each HTMA is used to analyze measured data for at least one relevant variable (RV) to determine whether the measured data is abnormal (i.e., outside of its upper and/or lower threshold limits) or normal (i.e., within its upper and/or lower threshold limits).

In accordance with these embodiments, when a parameter file 291 is received and loaded at the processor 290 of the ground support network 116, the processor 290 determines which relevant variables are included in the parameter file 291. For each relevant variable, the processor 290 loads and executes an appropriate AHTM program module 290 (that corresponds to the particular relevant variable). For each AHTM program module 290 and parameter file 291, an HTMA then analyzes the measured data for that relevant variable (RV) to determine whether that relevant variable is at an abnormal level (i.e., outside of its upper and/or lower threshold limits). If the measured data for that relevant variable is determined to be abnormal, the HTMA can flag the abnormality and then also further examine measured data for relevant parameters (RPs) that are associated with that particular relevant variable to determine which relevant parameters are most likely causing the relevant variable to be at an abnormal level.

To explain further, each HTMA has at least one relevant variable (RV) associated with it that is used during initial analysis of a particular sub-system of an aircraft or of a component of a particular sub-system. Each relevant variable is influenced or affected by a number of different relevant parameters (RPs). Each of the relevant parameters are also associated with the particular sub-system or component of the aircraft, and help characterize the performance or operational characteristics of that particular sub-system or component. For a particular HTMA, the relevant variables and the relevant parameters for each relevant variable, as well as thresholds (e.g., upper and/or lower thresholds) for each relevant variable and each of its relevant parameters, are pre-defined.

When a relevant variable is determined to be abnormal during execution of a particular HTMA, measured data for each of the relevant parameters corresponding to that relevant variable can then be compared to one or more thresholds, and any relevant parameters that are determined to be outside their respective threshold(s) can then be identified as being a potential cause of the abnormal relevant variable and can then be stored in an inspection file 296. In some implementations, the inspection file 296 can also indicate particular sub-system(s) (or components thereof) that each of the relevant parameters are associated with. This way, those particular sub-system(s) (or components thereof) can be easily identified for further inspection to determine whether they are operating correctly or whether corrective actions need to be taken.

CAS Message Embodiments

Many modern aircraft used Crew Alerting System (CAS) messages to provide engine and aircraft system fault information to the crew. CAS messages are annunciated to the crew based on triggers and logic embedded in the avionics suite. The logic typically contains inputs from all reporting aircraft systems and sub-systems. A CAS message is triggered when the combination of inputs meets the criteria of embedded logic. This could be Boolean or binary type inputs, or floating point parameters. Once the logic has been satisfied, the avionics suite displays a message to the crew in either Red (warning), Amber (caution), or Cyan (advisory). Many CAS messages display failure or fault information to the crew. In these instances when failure or fault information is displayed, it is assumed that the system has experienced an anomaly and a corrective action must be performed to successfully extinguish the CAS message. The system is records all of the CAS parameters at any given time. The CAS parameter value of the message is 0 until the CAS message becomes active. Once active, the value of the CAS parameter value changes from zero to an integer between one (1) and sixty-three (63) depending on what failed. As the CAS messages are recorded, the system is detects when the value of the parameter changes from zero to a non-zero value.

In accordance with some of the other disclosed embodiments, when a CAS message is generated on-board the aircraft 110, the data for relevant parameters (RPs) that are associated with that particular CAS message are automatically measured and stored in a parameter file 291 that is transmitted to the ground support network 116. Aircraft maintenance and engineering personnel can determine based on experience a number of different relevant parameters (RPs) that are the typical triggers for each particular CAS message. As such, for each particular CAS message, relevant parameters and their respective thresholds (e.g., upper and/or lower thresholds for each relevant parameter) can be pre-defined.

When a parameter file 291 is received and loaded at the processor 290 of the ground support network 116, the processor 290 also loads and executes an appropriate AHTM program module 293 (that corresponds to the particular CAS message indicated in the parameter file 291). When the processor 290 executes the HTMA that corresponds to the AHTM program module 293, the measured data for each of the relevant parameters (RPs) that are included in the parameter file 291 are analyzed to determine which of the relevant parameters are at an abnormal level (i.e., outside of its upper and/or lower threshold limits) and thus most likely causing that particular CAS message to be generated. Each of the relevant parameters can be compared to one or more thresholds, and any relevant parameters that are determined to be outside those threshold(s) can be identified as being a potential cause of the CAS message. When the measured data for any relevant parameter is determined to be abnormal, the HTMA can flag the abnormality and the relevant parameters that are outside of their respective threshold(s) can then be stored in an inspection file 296. In some implementations, the inspection file 296 can also indicate particular sub-system(s) (or components thereof) that each of the relevant parameters are associated with. This way, those particular sub-system(s) (or components thereof) can be identified and flagged for further inspection to determine whether they are operating correctly or whether corrective actions need to be taken.

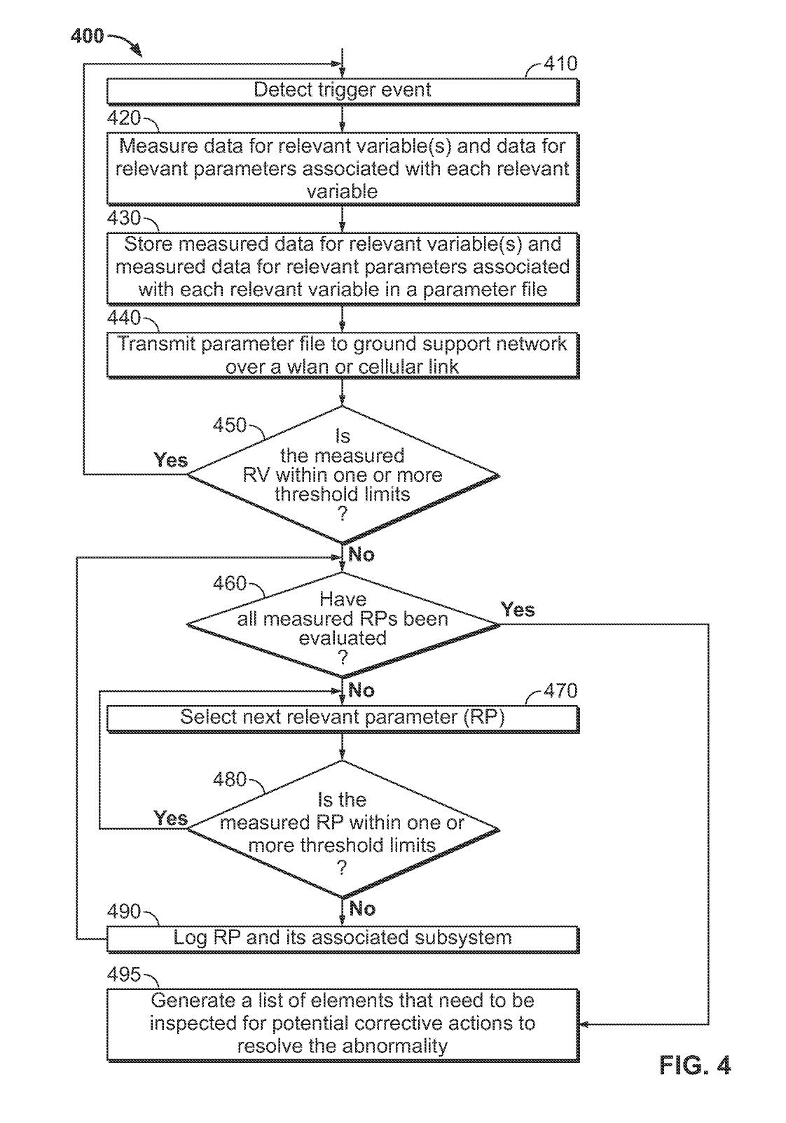

FIG. 4 is a flowchart of a method 400 for monitoring health and trending of an aircraft's various sub-systems (or components thereof) in accordance with some of the disclosed embodiments. The method 400 can be implemented as part of a health and trend monitoring algorithm (HTMA) to detect/identify/observe an abnormality in particular sub-system(s) (or components thereof), and to isolate/identify the underlying cause(s) of that abnormality (e.g., pinpoint the source(s) that are causing the abnormal condition). The method 400 of FIG. 4 will be described below with reference to FIGS. 1 through 3 to explain how the method 400 could be applied in the context of one exemplary, non-limiting environment.

Method 400 begins in a monitoring state at 410 where an on-board computer of the aircraft monitors its sub-system(s) (or components thereof) for occurrence of one or more trigger events (TEs).

When a trigger event is detected at 410, the method 400 enters a measurement state at 420. At 420, the on-board computer can measure: (1) data for at least one relevant variable (or a plurality of relevant variables), and (2) a data stream for each relevant parameter that is associated with (e.g., influences or affects) that relevant variable. As will be explained below, the relevant variables can be used by a ground support network 116 to identify when a relevant variable is starting to trend away from is normal or expected value, and the relevant parameters can then be used at the ground support network 116 to isolate the specific cause(s) of that abnormality.

In accordance with some of the disclosed embodiments, at 430, the measured data for a particular relevant variable and the measured data for each of the relevant parameters (that are associated with that relevant variable) can be stored in a parameter file (PF) corresponding to that particular relevant variable. Each particular relevant parameter can have a parameter name associated with it for easy identification. The data for each particular relevant parameter is unprocessed or raw data. For some of the relevant parameters, the data stream can be measured for a particular duration of time. For others of the relevant parameters, the data stream can be measured from a start trigger until a stop trigger occurs. In some embodiments, a number of parameter files can be combined into a single master parameter file that includes parameter files for each of the relevant variables that are used in conjunction with a particular health monitoring algorithm.

At 440, the parameter file is transmitted from the aircraft via a WLAN communication link 130 or a cellular communication link 132, and relayed to the ground support network 116. The ground support network 116 receives the data, and uncompresses the data from one format into another format that is readable and usable.

At 450, a detection state is executed at the ground support network 116, where the ground support network 116 processes the measured data for the relevant variables) and determines whether the measured data for the relevant variable is within one or more threshold limits. Depending on the HTMA that is being executed, the threshold limits can be, for example, state thresholds (e.g., binary 0 or binary 1); time thresholds (either being less than or more than a specific time), data thresholds of data (e.g., being less than or more than a specific value of data), parameter value thresholds, etc. In some implementations, when the HMTA includes multiple relevant variable(s), the ground support network 116 can process them sequentially, however, in other embodiments, the ground support network 116 can process all of the measured data for the relevant variables in the parameter file in parallel. For sake of simplicity, the description that follows presumes that the HMTA includes a single relevant variable.

When the HMTA determines that the measured data for the relevant variable is within one or more threshold limits, this means that no abnormal condition has been detected, and the method 400 loops back to 410.

When the HMTA determines that the measured data for the relevant variable is outside one or more threshold limits (e.g., are above or below expected values) this means that an abnormal condition has been detected (e.g., that the HMTA detects/identifies/observes an abnormality in that sub-system), and the method 400 proceeds to 460, where the HMTA enters an identification state to determine/identify/isolate one or more underlying cause(s) of the abnormality or abnormal condition that may have been the cause of that particular relevant variable falling outside of its threshold(s).

To do so, in one embodiment, the HMTA can analyze each relevant parameter (at 470/480) and determine which relevant parameters have measured values that lie outside their thresholds (i.e., are not within their expected values). At 470, the HMTA selects the next relevant parameter in the parameter file. During the first iteration of method 400, this is the first relevant parameter in the parameter file and during the last iteration, this is the last relevant parameter in the parameter file.

At 480, a determination is made as to whether the measured data for a particular relevant parameter is within one or more threshold limits (e.g., within an upper threshold and/or within a lower threshold). When the measured data for a particular relevant parameter is within its threshold limits, the method 400 loops back to 470 to determine whether or not any other measured data for the relevant parameters need to be analyzed. When the measured data for a particular relevant parameter is outside of one or more threshold limits (e.g., greater than or less than one ore more of the threshold limits), at 490, the relevant parameter can be stored, for example, in an identification file along with an indication of the element (e.g., particular sub-system(s) or component thereof) that it applies to (and/or displayed on a display), and the method the loops back to 460.

Thus, at 490, any relevant parameters that are determined to have measured data values that lie outside their thresholds can be logged (e.g., recorded and stored). In one implementation, the relevant parameters can be logged in an identification file that identifies the relevant parameters and the elements (e.g., particular sub-system(s) (or components thereof)) that those are relevant parameters are associated with. In some implementations, the relevant parameters can be displayed on a graphical user interface (GUI) (e.g., as a web page) at the ground support network.

At 495, a list of elements can be generated that need to be inspected for potential corrective actions to resolve the abnormality. Personnel can review this information and create other information. For example, in one implementation, personnel can review information in an identification file and create other information (e.g., an inspection file that is generated based on information from the identification file or information elements needed to create a web page at a terminal of the ground support network). In addition, personnel can inspect the elements included in the reviewed information and take corrective actions needed to restore the elements that are the cause (or potential cause) of the abnormality (with respect to anticipated or normal operating conditions) before the abnormality becomes significant. For example, personnel can inspect the elements that are included in the inspection file to determine what corrective actions (if any) need to be taken to resolve the abnormality.

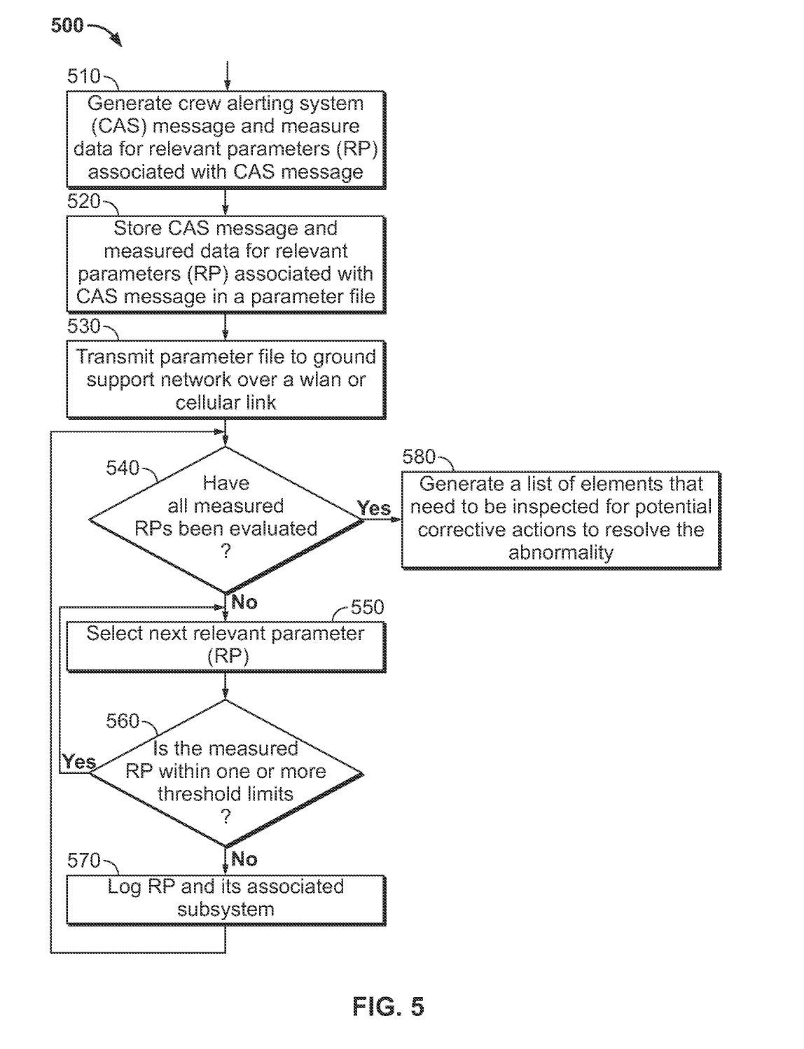

FIG. 5 is a flowchart of another method 500 for monitoring health and trending of an aircraft's various sub-systems (or components thereof) in accordance with some of the other disclosed embodiments. Method 500 can be used to detect/identify/observe an abnormality in an aircraft sub-system (or components thereof), and to isolate/identify the underlying cause(s) of that abnormality (e.g., pinpoint the source(s) that are causing the abnormal condition). The method 500 of FIG. 5 will be described below with reference to FIGS. 1 through 2B to explain how the method 500 could be applied in the context of one exemplary, non-limiting environment.

Method 500 begins in a monitoring state at 510 where a computer on-board the aircraft monitors for and waits to receive a crew alerting system (CAS) message. The CAS message triggers an announcement to the crew of the aircraft, and automatically indicates that a relevant variable is outside of its threshold(s). For example, in some implementations, certain logical bits, which indicate failures can be logically processed (e.g., are AND-ed and OR-ed) in the avionics software to define when a CAS message is annunciated in the aircraft. These bits, in general, indicate an abnormal condition. A CAS message necessarily indicates that a measured variable is outside one or more threshold limits (e.g., is above or below expected values), which indicates that an abnormal condition has been detected (e.g., that the HMTA detects/identifies/observes an abnormality in that sub-system). When the CAS message is generated, data for each one of a set of relevant parameters that are associated with that particular CAS message are measured and recorded.

When a CAS message is generated at 510, the CAS message and data for each of the relevant parameters associated with that CAS message can be measured and stored in a parameter file corresponding to that CAS message at 520. Each particular relevant parameter can have a parameter name associated with it for easy identification. The data for each particular relevant parameter is unprocessed or raw data. With respect to any CAS message, a data stream can be measured for the relevant parameter(s) for a particular duration of time based on the initial trigger event (that caused the CAS message to be generated). In some embodiments, a number of parameter files can be combined into a single master parameter file that includes parameter files for each of the relevant variables that are used in conjunction with a particular health monitoring algorithm.

At 530, the parameter file is transmitted from the aircraft via a satellite communication link 111, and then relayed to the ground support network 116.

In some implementations, the CAS messages can have different priorities, and only the high priority CAS messages are immediately sent to the ground support network. Higher priority CAS messages and their associated parameter file (with relevant parameters) can be transmitted during flight to the ground support network 116 immediately following generation of the parameter file via a satellite communication link 111 at 430. In this embodiment, a satellite communication link 111 is used primarily because the aircraft is in flight and there is no WLAN communication link 130 or cellular communication link 132 available. The higher priority CAS messages needs to be transmitted before the aircraft lands, so the only way to do that is to use some type of satellite communication path. The WLAN communication link 130 or the cellular communication link 132 become available once the aircraft is on the ground. Lower priority CAS messages and their associated parameter file with relevant parameters can be transmitted to the ground support network 116 when the aircraft lands via a WLAN communication link 130 or a cellular communication link 132.

Personnel who are located remotely with respect to the ground support network 116 can view the parameter file (that includes data that was collected in real time on the aircraft when an event occurred) on a computer interface 122 that is coupled to the ground support network 116 via server 118. Personnel can use information in the parameter file to provide a list of items that need to be inspected to ground support crew.

At 540, an identification state begins where the ground support network 116 begins processing the measured data for the relevant parameters that were included in the parameter file to determine/identify/isolate one or more underlying cause(s) of the abnormality or abnormal condition that may have been the cause of the CAS message. To do so, in one embodiment, the HMTA can analyze each relevant parameter (at 550/560) and determine which relevant parameters have measured values that lie outside their corresponding thresholds (i.e., are not within their expected values).

At 550, the next relevant parameter in the parameter file can be selected. During the first iteration of method 500, this is the first relevant parameter in the parameter file and during the last iteration this is the last relevant parameter in the parameter file.

At 560, a determination is made whether the measured data for a particular relevant parameter is within one or more threshold limits (e.g., within an upper threshold and/or within a lower threshold).

When the measured data for that particular relevant parameter is within its threshold limits, the method 500 loops back to 550 to determine whether or not any other measured data for other relevant parameters needs to be analyzed.

When the measured data for that particular relevant parameter is outside of one or more threshold limits (e.g., greater than or less than one ore more of the threshold limits), at 570 that relevant parameter is logged along with an indication of the sub-system that it applies (for example, to in an identification file), and the method the loops back to 560. Thus, at 570, any relevant parameters that are determined to have measured data values that lie outside their thresholds are logged (e.g., recorded and stored) in the identification file that identifies the relevant parameters and the elements (e.g., particular sub-system(s) (or components thereof)) that those are relevant parameters are associated with.

At 580, a list of elements can be generated that need to be inspected for potential corrective actions to resolve the abnormality. Personnel can review this information and create other information.

For example, in one implementation, personnel can review this information and create other information. For instance, personnel can review information in an identification file and create other information. (e.g., an inspection file that is generated based on information from the identification file or information elements needed to create a web page at a terminal of the ground support network). In addition, personnel can inspect the elements included in the reviewed information and take corrective actions needed to restore the elements that are the cause (or potential cause) of the abnormality (with respect to anticipated or normal operating conditions) before the abnormality becomes significant. For example, personnel can inspect the elements that are included in the inspection file to determine what corrective actions (if any) need to be taken to resolve the abnormality. In some embodiments, the information can be displayed on a display.

The flowcharts that are illustrated in FIGS. 4 and 5 are exemplary, and are simplified for sake of clarity. In some implementations, additional blocks/tasks/steps can be implemented even though they are not illustrated for sake of clarity. These additional blocks/tasks/steps may occur before or after or in parallel and/or concurrently with any of the blocks/tasks/steps that are illustrated in FIGS. 4 and 5. It is also noted that some of the blocks/tasks/steps illustrated in FIGS. 4 and 5 may be optional and do not need to be included in every implementation of the disclosed embodiments. In some implementations, although not illustrated, the presence or absence of certain conditions may need to be confirmed prior to execution of a block/task/step or prior to completion of a block/task/step. In other words, a block/task/step may include one or more conditions that are to be satisfied before proceeding from that block/task/step to the next block/task/step of FIGS. 4 and 5. For example, in some cases, a timer, a counter or combination of both may execute and need to be satisfied before proceeding to the next block/task/step of the flowchart. As such, any block/task/step can be conditional on other blocks/tasks/steps that are not illustrated in FIGS. 4 and 5.

It is also noted that there is no order or temporal relationship implied by the flowcharts of FIGS. 4 and 5 unless the order or temporal relationship is expressly stated or implied from the context of the language that describes the various blocks/tasks/steps of the flowchart. The order of the blocks/tasks/steps can be varied unless expressly stated or otherwise implied from other portions of text.

In addition, in some implementations, FIGS. 4 and 5 may include additional feedback or feedforward loops that are not illustrated for sake of clarity. The absence of a feedback or a feedforward loop between two points of the flowchart does not necessarily mean a feedback or feedforward loop is not present between the two points. Likewise, some feedback or feedforward loops may be optional in certain implementations. Although FIGS. 4 and 5 are illustrated as including a single iteration this does not necessarily imply that the flowchart does not execute for a certain number of iterations or continuously or until one or more conditions occur.

The health and trend monitoring algorithms (HTMAs) that are described above can be designed to apply to any one of a number of aircraft sub-systems (or components thereof), and some specific examples of trigger events, relevant variables, and relevant parameters will now be given in conjunction with some examples of such HTMAs in which they apply. As described above, those skilled in the art will appreciated that each of the HTMAs that are described below can be implemented using computer executable instructions that are stored in memory 292 of the ground support network 116 as an AHTM program module 293 that is executed on the processor 290.

Algorithms for Aircraft Landing Gear Systems

Landing Gear Extension HTMA

In one implementation, a landing gear extension HTMA is provided. For an aircraft landing gear, the gear extension sequence is accomplished by moving a handle in the cockpit, this in turn drives a solenoid valve which puts pressure to the landing gear actuator which extends the gear. The pilot knows the gear is down when a “down and lock” switch is activated.

The landing gear extension HTMA is triggered in response to detecting that the landing gear handle of the aircraft has been moved down position. For the landing gear extension HTMA, the relevant variable that is measured and recorded is the landing gear extension time. The relevant parameters that are recorded and stored for the landing gear extension HTMA can include date and time stamps, hydraulic pressures, valve positions, temperatures, quantities, rates, flap positions, altitude, airspeed, acceleration, air temperature, total fuel, ice detection, landing gear, gear door position, aircraft weight, landing gear and flap handle position, and status parameters. The relevant parameters for the landing gear extension HTMA can be used to identify which parameters are causing the landing gear extension time to trend away from its normal or expected value. By measuring and analyzing these relevant parameters, abnormalities such as sticky valves, friction due to corrosion, etc. may be detected without the expense of comprehensive and costly maintenance inspections.

Landing Gear Retraction and Wheel Speed HTMA

In another implementation, a landing gear retraction and a nose and main landing gear wheel speed upon retraction HTMA is provided. The landing gear retraction and wheel speed HTMA is triggered in response to detecting that the landing gear handle of the aircraft has been moved into an up position. For the landing gear retraction and wheel speed HTMA the relevant variables that are measured and recorded are the landing gear retraction time and wheel speed. The relevant parameters that are recorded and stored for the landing gear retraction and wheel speed HTMA can include date and time stamps, wheel speeds, hydraulic pressures, valve positions, temperatures, quantities, rates, flap positions, altitude, airspeed, acceleration, air temperature, total fuel, ice detection, landing gear, gear door position, aircraft weight, landing gear and flap handle position, and status parameters. The relevant parameters for the landing gear retraction and wheel speed HTMA can be used to identify which parameters are causing either the landing gear retraction time and, or wheel speed to trend away from their normal or expected values.

Algorithms for Aircraft Braking Systems: Brake Temperature HTMA

In another implementation, a brake temperature HTMA is provided. The brake temperature HTMA is triggered in response to detecting that weight is on the wheels of the nose landing gear (e.g. the aircraft has landed on the runway). For the brake temperature HTMA the relevant variable that is measured and recorded is the temperature of each landing gear brake during landing. The relevant parameters that are recorded and stored for the brake temperature HTMA can include date and time stamps, hydraulic pressures, valve positions, temperatures, quantities, rates, altitude, speed, air temperature, total fuel, aircraft weight, landing gear weight on wheels sensor, and status parameters. The relevant parameters for the brake temperature HTMA can be used to identify which parameters are causing the brake temperature to trend away from its normal or expected value.

Algorithms for Aircraft Communication Systems

VHF Communication Link Availability HTMA

In another implementation, a VHF communication link availability HTMA is provided. The VHF communication link availability HTMA is triggered in response to detecting that the VHF communication link is unavailable. For the VHF communication link availability HTMA the relevant variable that is measured and recorded is the latitude and longitude where the VHF communication link is unavailable. The relevant parameters that are recorded and stored for the VHF communication link availability HTMA can include date and time stamps, positional information (latitude and longitude), air temperature, airspeed, altitude, and communication link channel, status and availability. The relevant parameters for the VHF communication link availability HTMA can be used to identify when the VHF communication link is unavailable.

Satellite Communication Link Availability HTMA

In another implementation, a satellite communication link availability HTMA is provided. The satellite communication link availability HTMA is triggered in response to detecting that the satellite communication link is unavailable. For the satellite communication link availability HTMA the relevant variable that is measured and recorded is the latitude and longitude where the satellite communication link is unavailable. The relevant parameters that are recorded and stored for the satellite communication link availability HTMA can include date and time stamps, positional information (latitude and longitude), air temperature, airspeed, altitude, and communication link channel, status and availability. The relevant parameters for the satellite communication link availability HTMA can be used to identify when the satellite communication link is unavailable.

Communications Management Function (CMF) Availability HTMA

In another implementation, a CMF availability HTMA is provided. The CMF availability HTMA is triggered in response to detecting that the CMF is unavailable. For the CMF availability HTMA the relevant variable that is measured and recorded is latitude and longitude where the CMF communication link is unavailable. The relevant parameters that are recorded and stored for the CMF availability HTMA can include date and time stamps, positional information (latitude and longitude), air temperature, airspeed, altitude, and communication link channel, status and availability. The relevant parameters for the CMF availability HTMA can be used to identify when the CMF is unavailable.

Algorithms for Aircraft Power Systems

A/C Power-up HTMA

In another implementation, an A/C power-up HTMA is provided. The A/C power-up HTMA is triggered in response to detecting that a master switch has been turned on. For the A/C power-up HTMA the relevant variables that are measured and recorded include battery temperature, current and voltage, Automatic Power Unit (APU) generator temperature, current and voltage, and Transformer Rectifier Unit (TRU) temperature, current and voltage. The relevant parameters that are recorded and stored for the A/C power-up HTMA can include date and time stamps, main and backup battery charge, temperature, volts, current, main and backup transformer rectifier unit voltage, load, frequency, external power voltage, load, frequency, auxiliary power unit voltage, load, frequency, and air temperature. The relevant parameters for the A/C power-up HTMA can be used to identify which parameters are causing the temperature, current or voltage at the battery, APU generator or TRU to trend away from their normal or expected values during A/C power-up.

Integrated Drive Generator (IDG) HTMA

In another implementation, an IDG HTMA is provided. The IDG HTMA is triggered in response to detecting that the left or right engine has been started. For the IDG HTMA the relevant variable that is measured and recorded is the engine power generation of the left or right engine. The relevant parameters that are recorded and stored for the IDG HTMA can include date and time stamps, engine start discrete inputs, N1, N2 speeds, transformer rectifier unit voltage, load, integrated drive generator frequency, load factors, voltage. The relevant parameters for the IDG HTMA can be used to identify which parameters are causing the engine power generation by the IDG of the left or right engine to trend away from a normal or expected value.

Auxiliary Power Unit (APU) HTMA

In another implementation, an APU HTMA is provided. The APU HTMA is triggered in response to detecting that the APU has been started. For the APU HTMA the relevant variable that is measured and recorded is the timeframe in which the APU door opens and closes and APU voltage, current. The relevant parameters that are recorded and stored for the APU HTMA can include date and time stamps, APU door indicators, APU door actuators, APU speeds, fuel flow, valve positions, volts, APU door position, air temperature, altitude, altitude rate, accelerations (body). The relevant parameters for the APU HTMA can be used to identify which parameters are causing the APU door opening or starting characteristics to trend away from a normal or expected value.

Automatic Power Unit (APU) Inlet Door HTMA

In another implementation, an APU inlet door HTMA is provided. The APU inlet door HTMA is triggered in response to detecting that a master switch has been turned on. For the APU inlet door HTMA the relevant variables that are measured and recorded can include the opening and closing times for the APU inlet door. The relevant parameters that are recorded and stored for the APU inlet door HTMA can include date and time stamps, APU door indicators, APU door actuators, APU speeds, fuel flow, valve positions, volts, APU door position, air temperature, altitude, altitude rate, accelerations (body). The relevant parameters for the APU inlet door HTMA can be used to identify which parameters are causing the opening and closing times for the APU inlet door to trend away from a normal or expected value.

Engine Start-Up HTMAs

In another implementation, an engine start-up HTMA is provided. The engine start-up HTMA is triggered in response to detecting that either the left or right engine has been started. For the engine start-up HTMA the relevant variables that are measured and recorded are engine vibration, EPR and fuel flow when the left or right engine is started. The relevant parameters that are recorded and stored for the engine start-up HTMA can include date and time stamps, turbine gas temperatures, vibrations, N1, N2 speeds, valve positions, oil pressures, temperatures, fuel flow, temperatures, pressure ratios. The relevant parameters for the engine start-up HTMA can be used to identify which parameters are causing the engine vibration, EPR and fuel flow (of the left or right engine) to trend away from their normal or expected values during start-up.

Algorithms for Flight Control Surface Movements

Aileron and Aileron Trim Tab Movement HTMAs

In another implementation, an aileron and aileron trim tab movement HTMA is provided. The aileron and aileron trim tab movement HTMA is triggered in response to detecting that calibrated air speed is greater than a threshold. For the aileron and aileron trim tab movement HTMA the relevant variables that are measured and recorded are initial +, − movement of the aileron, initial +, − movement of the aileron trim tab, a position difference between the left and right aileron, and a position difference between the left and right aileron trim tab, pilot input versus actual movement of the left or right aileron, pilot input versus actual movement of the left or right aileron trim tab. The relevant parameters that are recorded and stored for the aileron and aileron trim tab movement HTMA can include date and time stamps, roll angles, air temperature, airspeed, altitude, flight control surface position, servo clutch states, pilot, copilot column forces, servo drum positions, trim positions, landing gear information parameters, flight control computer status bits. The relevant parameters for the aileron and aileron trim tab movement HTMA can be used to identify which parameters are causing movement of the ailerons or aileron trim tabs to trend away from their normal or expected values during start-up.

Rudder and Rudder Trim Movement HTMAs

In another implementation, a rudder and trim movement HTMA is provided. The rudder and trim movement HTMA is triggered in response to detecting that calibrated air speed is greater than a threshold. For the rudder and trim movement HTMA the relevant variables that are measured and recorded are initial +, − movement of the rudder, initial +, − movement of the trim, a position difference between the rudder pedal position and the actual rudder position, a position difference between pilot input versus actual movement of the aileron, and a position difference between pilot input versus actual movement of the rudder. The relevant parameters that are recorded and stored for the rudder and trim movement HTMA can include date and time stamps, yaw angles, air temperature, airspeed, altitude, flight control surface position, servo clutch states, pilot, copilot column forces, rudder pedal position, forces, rudder trim position, servo drum positions, trim positions, landing gear information parameters, flight control computer status bits. The relevant parameters for the rudder and trim movement HTMA can be used to identify which parameters are causing movement of the rudders or trim to trend away from their normal or expected values.

Elevator and Elevator Trim Tab Movement HTMAs

In another implementation, an elevator and elevator trim tab movement HTMA is provided. The elevator and elevator trim tab movement HTMA is triggered in response to detecting that calibrated air speed is greater than a threshold. For the elevator and elevator trim tab movement HTMA the relevant variables that are measured and recorded are initial +, − movement of the elevator, initial +, − movement of the elevator trim tab, a position difference between pilot input versus actual movement of the elevator trim tab, and a position difference between pilot input versus actual movement of the elevator. The relevant parameters that are recorded and stored for the elevator and elevator trim tab movement HTMA can include date and time stamps, pitch angles, air temperature, airspeed, altitude, flight control surface position, servo clutch states, pilot, copilot column forces, servo drum positions, trim positions, landing gear information parameters, flight control computer status bits. The relevant parameters for the elevator and elevator trim tab movement HTMA can be used to identify which parameters are causing movement of the elevators or elevator trim tab to trend away from their normal or expected values.

Flap Position HTMAs

In another implementation, a flap position HTMA is provided. The flap position HTMA is triggered in response to detecting that calibrated air speed is greater than a threshold. For the flap position HTMA the relevant variables that are measured and recorded are flap position, air speed, the time between commanding the flaps to a position and the flaps attaining that position, and a position difference between the right flap position and the left flap position. The relevant parameters that are recorded and stored for the flap position HTMA can include date and time stamps, flap positions, air temperature, airspeed, altitude, landing gear position information, flap handle position. The relevant parameters for the flap position HTMA can be used to identify which parameters are causing the flap positions to trend away from their normal or expected values.

Spoiler Position HTMAs

In another implementation, a spoiler position HTMA is provided. The spoiler position HTMA is triggered in response to detecting that calibrated air speed is greater than a threshold. For the spoiler position HTMA the relevant variables that are measured and recorded are spoiler position and air speed. The relevant parameters that are recorded and stored for the spoiler position HTMA can include date and time stamps, air temperature, airspeed, altitude, landing gear position information, speed brake handle position, flight control computer status bits, spoiler positions. The relevant parameters for the spoiler position HTMA can be used to identify which parameters are causing the spoiler positions to trend away from their normal or expected values.

Horizontal Stabilizer HTMA

In another implementation, a horizontal stabilizer HTMA is provided. The horizontal stabilizer HTMA is triggered in response to detecting that calibrated air speed is greater than a threshold. For the horizontal stabilizer HTMA the relevant variables that are measured and recorded are initial +, − movement of the horizontal stabilizer. The relevant parameters that are recorded and stored for the horizontal stabilizer HTMA can include date and time stamps, air temperature, airspeed, altitude, landing gear position information, flight control computer status bits, horizontal stabilizer position, mode. The relevant parameters for the horizontal stabilizer HTMA can be used to identify which parameters are causing movement of the horizontal stabilizer to trend away from its normal or expected values.

Thrust Reverser Position HTMA

In another implementation, a thrust reverser HTMA is provided. The thrust reverser HTMA is triggered in response to detecting that a thrust reverser has been deployed or stowed. For the thrust reverser HTMA the relevant variable that is measured and recorded is the thrust reverser position and the time it takes the thrust reverser to stow and deploy. The relevant parameters that are recorded and stored for the thrust reverser HTMA can include date and time stamps, engine data, fuel flow, thrust reverser positions, aircraft weight, speed. The relevant parameters for the thrust reverser HTMA can be used to identify which parameters are causing the position of the thrust reverser to trend away from its normal or expected value when it is deployed or stowed.

Wing and Cowl Anti-Ice HTMA

In another implementation, a wing and cowl anti-ice HTMA is provided. The wing and cowl anti-ice HTMA is triggered in response to detecting that a wing or cowl anti-ice system is on. For the wing and cowl anti-ice HTMA the relevant variables that are measured and recorded are a temperature difference between the temperature when the wing anti-ice system was turned off and a temperature when the wing anti-ice system was turned on, and motor torque and current (wing) or pressure (cowl) versus temperature. The relevant parameters that are recorded and stored for the wing anti-ice HTMA can include date and time stamps, wing anti-ice temperature, motor currents, airspeed, altitude, ice detection status, N1, N2 speeds, cowl anti-ice pressures, wing, cowl anti-ice on status. The relevant parameters for the wing anti-ice HTMA can be used to identify which parameters are causing the performance of the wing anti-ice system to trend away from its normal or expected performance.

Health Algorithms for Aircraft Steering

Angle of Attack Miscompare HTMA

In another implementation, angle of attack miscompare HTMA is provided. The angle of attack miscompare HTMA is triggered in response to detecting that any one of the four air data probes is calculating values that are much higher or much lower than the other probes. For the angle of attack miscompare HTMA the relevant variables that are measured and recorded are the differences among the four air data probes. The relevant parameters that are recorded and stored for the angle of attack miscompare HTMA can include date and time stamps, angle of attack for all probes, angle of sideslip for all probes, static, total pressure for all probes, airspeed, altitude and rate, impact pressure, AOA Miscompare CAS message data. The relevant parameters for the angle of attack miscompare HTMA can be used to identify which probe is trending away from its normal or expected performance.

Angle of Attack Takeoff HTMA

In another implementation, an angle of attack takeoff HTMA is provided. The angle of attack takeoff HTMA is triggered in response to detecting that any one of the four air data probes is calculating values that are much higher or much lower than the other probes. For the angle of attack takeoff HTMA the relevant variables that are measured and recorded are the differences among the four air data probes. The relevant parameters that are recorded and stored for the angle of attack takeoff HTMA can include date and time stamps, angle of attack for all probes, angle of sideslip for all probes, static, total pressure for all probes, airspeed, altitude and rate, impact pressure, AOA Miscompare CAS message data. The relevant parameters for the angle of attack takeoff HTMA can be used to identify which parameters are causing probe is trending away from its normal or expected performance.

Angle of Attack Climb HTMA

In another implementation, an angle of attack climb HTMA is provided. The angle of attack climb HTMA is triggered in response to detecting that any one of the four air data probes is calculating values that are much higher or much lower than the other probes. For the angle of attack climb HTMA the relevant variables that are measured and recorded are the differences among the four air data probes. The relevant parameters that are recorded and stored for the angle of attack climb HTMA can include date and time stamps, angle of attack for all probes, angle of sideslip for all probes, static, total pressure for all probes, airspeed, altitude and rate, impact pressure, AOA Miscompare CAS message data. The relevant parameters for the angle of attack climb HTMA can be used to identify which parameters are causing probe is trending away from its normal or expected performance.

Angle of Attack Cruise 1 HTMA

In another implementation, an angle of attack cruise 1 HTMA is provided. The angle of attack cruise 1 HTMA is triggered in response to detecting that any one of the four air data probes is calculating values that are much higher or much lower than the other probes. For the angle of attack cruise 1 HTMA the relevant variables that are measured and recorded are the differences among the four air data probes. The relevant parameters that are recorded and stored for the angle of attack cruise 1 HTMA can include date and time stamps, angle of attack for all probes, angle of sideslip for all probes, static, total pressure for all probes, airspeed, altitude and rate, impact pressure, AOA Miscompare CAS message data. The relevant parameters for the angle of attack cruise 1 HTMA can be used to identify which parameters are causing probe is trending away from its normal or expected performance.

Angle of Attack Cruise 2 HTMA

In another implementation, an angle of attack cruise 2 HTMA is provided. The angle of attack cruise 2 HTMA is triggered in response to detecting that any one of the four air data probes is calculating values that are much higher or much lower than the other probes. For the angle of attack cruise 2 HTMA the relevant variables that are measured and recorded are the differences among the four air data probes. The relevant parameters that are recorded and stored for the angle of attack cruise 2 HTMA can include date and time stamps, angle of attack for all probes, angle of sideslip for all probes, static, total pressure for all probes, airspeed, altitude and rate, impact pressure, AOA Miscompare CAS message data. The relevant parameters for the angle of attack cruise 2 HTMA can be used to identify which parameters are causing probe is trending away from its normal or expected performance.

Angle of Attack Descent HTMA

In another implementation, an angle of attack descent HTMA is provided. The angle of attack descent HTMA is triggered in response to detecting that any one of the four air data probes is calculating values that are much higher or much lower than the other probes. For the angle of attack descent HTMA the relevant variables that are measured and recorded are the differences among the four air data probes. The relevant parameters that are recorded and stored for the angle of attack descent HTMA can include date and time stamps, angle of attack for all probes, angle of sideslip for all probes, static, total pressure for all probes, airspeed, altitude and rate, impact pressure, AOA Miscompare CAS message data. The relevant parameters for the angle of attack descent HTMA can be used to identify which parameters are causing probe is trending away from its normal or expected performance.

Algorithms for Aircraft Cabin Environment

Enhanced Vision System (EVS) Temperature HTMA

In another implementation, an EVS temperature HTMA is provided. The EVS temperature HTMA is triggered in response to detecting that a valid video signal from the EVS. For the EVS temperature HTMA the relevant variables that are measured and recorded are the EVS temperature sensors. The relevant parameters that are recorded and stored for the EVS temperature HTMA can include date and time stamps, video valid parameters, temperature sensor information, elapsed time for the camera, processor.

### CONCLUSION

The disclosed aircraft health and trend monitoring methods and systems link on-board aircraft systems with a ground-based support network. The disclosed aircraft health and trend monitoring methods and systems can detect degradation of performance of an aircraft's various components and sub-systems and that can identify the specific source of a potential fault within particular components and sub-systems of the aircraft. The disclosed aircraft health and trend monitoring methods and systems can measure and store relevant parameter data for various aircraft components and sub-systems, and communicate that relevant parameter data from the aircraft to a ground support network without crew intervention so that a detailed off-board analysis of the data acquired from the aircraft can be performed and corrective actions can be taken. The disclosed aircraft health and trend monitoring methods and systems can reduce the amount of time needed to identify and diagnose problems and perform routine troubleshooting and aircraft maintenance tasks. In-flight issues can be identified for ground-based crews as soon as they occur to facilitate the development and implementation of quick and efficient return-to-service when the aircraft lands. The precise source of technical issues on the aircraft can be identified much more rapidly, and the time spent in conducting aircraft maintenance tasks can be significantly reduced. In addition, potential problems with a particular sub-system can be identified before that sub-system fails.

Those of skill in the art would further appreciate that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A system, comprising:
an aircraft having a plurality of sub-systems, the aircraft comprising:
a first processor that is configured to monitor the sub-systems to detect a trigger event during flight of the aircraft and to measure, in response to detecting the trigger event, data for a plurality of relevant parameters;
a first memory configured to store measured data for each of the relevant parameters in a parameter file; and
a transmitter operable to transmit the parameter file from the aircraft over a wireless communication link; and
a ground support network configured to receive the parameter file and to identify one or more sources that are causing an abnormal condition, the ground support network comprising:
a second memory configured to store a plurality of aircraft health and trend monitoring (AHTM) program modules; and
a second processor configured to execute a selected one of the AHTM program modules and process the measured data for the plurality of the relevant parameters to identify the one or more sources that are causing the abnormal condition.

2. A system according to claim 1, wherein the first processor is further configured to measure data for a relevant variable in response to detecting the trigger event, and wherein each relevant parameter is associated with the relevant variable and influences or affects the data that is measured for the relevant variable.

3. A system according to claim 2, wherein the first memory is further configured to store the measured data for the relevant variable in the parameter file.

4. A system according to claim 3, wherein the second processor is further configured to determine whether the measured data for the relevant variable is within one or more threshold limits or is trending away from a normal value, wherein the abnormal condition is detected when the measured data for the relevant variable is determined to be outside of the one or more threshold limits.

5. A system according to claim 4, wherein the second processor is further configured to determine, only when the measured data for the relevant variable is determined to be outside one or more threshold limits, whether the measured data for each particular relevant parameter is within a particular threshold associated with that particular relevant parameter, and
wherein the second processor is further configured to generate information comprising each of the particular relevant parameters that are determined to have measured data that is outside of the particular threshold associated with that particular relevant parameter, and wherein the particular relevant parameters that are included in the information have been identified as being a source that is causing the measured data for the relevant variable to be outside one or more threshold limits.

6. A system according to claim 1, wherein the second processor is further configured to determine whether the measured data for that particular relevant parameter is within a particular threshold associated with that particular relevant parameter, and
wherein the second processor is further configured to generate information comprising each of the particular relevant parameters that are determined to have measured data that is outside of the particular threshold associated with that particular relevant parameter, and wherein the particular relevant parameters that are included in the information have been identified as being an source that is causing the measured data for the relevant variable to be outside one or more threshold limits.

7. A system according to claim 1, wherein the trigger event comprises receipt of a crew alerting system (CAS) message by a computer on board the aircraft, and wherein the CAS message automatically indicates that measured data for a relevant variable of one of the sub-systems is outside one or more threshold limits and that an abnormal condition has been detected.

8. A system according to claim 1, wherein the measured data for each of the plurality of relevant parameters comprises a data stream for that particular relevant parameter that is measured for a particular duration of time.

9. A system according to claim 1, wherein the wireless communication link comprises either:
a wireless local area network communication link; or
a cellular network communication link.

10. A method for monitoring sub-systems of an aircraft to detect an abnormal condition and identifying one or more sources that are causing the abnormal condition, the method comprising:
detecting a trigger event during flight of the aircraft;
measuring, in response to detecting the trigger event, data for a plurality of relevant parameters;
storing the measured data for each of the relevant parameters in parameter information;
transmitting the parameter information from the aircraft over a wireless communication link and relaying the parameter information to a ground support network; and
using the measured data for the plurality of the relevant parameters at the ground support network to identify the one or more sources that are causing the abnormal condition.

11. A method according to claim 10, wherein the step of measuring further comprises:
measuring, in response to detecting the trigger event, data for a relevant variable and data for a plurality of relevant parameters, wherein each relevant parameter is associated with the relevant variable and potentially influences or affects the data that is measured for the relevant variable.

12. A method according to claim 11, wherein the step of storing further comprises:
storing the measured data for the relevant variable and the measured data for each of the relevant parameters that are associated with that relevant variable in parameter information corresponding to that particular relevant variable.

13. A method according to claim 12, further comprising:
determining, at the ground support network, whether the measured data for the relevant variable is trending away from a normal value.

14. A method according to claim 12, wherein determining, at the ground support network, whether the measured data for the relevant variable is trending away from a normal value, comprises:
determining, at the ground support network, whether the measured data for the relevant variable is within one or more threshold limits.

15. A method according to claim 14, wherein the abnormal condition is detected when the measured data for the relevant variable is determined to be outside of the one or more threshold limits.

16. A method according to claim 14, wherein the step of using the measured data for the plurality of the relevant parameters at the ground support network to identify the one or more sources that are causing the abnormal condition, comprises:
when the measured data for the relevant variable is determined to be outside one or more threshold limits, determining, for each particular relevant parameter, whether the measured data for that particular relevant parameter is within the particular threshold associated with that particular relevant parameter; and
generating information comprising each of the particular relevant parameters that are determined to have measured data that is outside of the particular threshold associated with that particular relevant parameter, wherein the particular relevant parameters that are included in the information have been identified as being a source that is causing the measured data for the relevant variable to be outside one or more threshold limits.

17. A method according to claim 10, wherein the step of using the measured data for the plurality of the relevant parameters at the ground support network to identify the one or more sources that are causing the abnormal condition, comprises:
determining, for each particular relevant parameter, whether the measured data for that particular relevant parameter is within a particular threshold associated with that particular relevant parameter; and
generating information comprising each of the particular relevant parameters that are determined to have measured data that is outside of the particular threshold associated with that particular relevant parameter, wherein the particular relevant parameters that are included in the information have been identified as being an source that is causing the measured data for the relevant variable to be outside one or more threshold limits.

18. A method according to claim 10, wherein the trigger event comprises:
receipt of a crew alert system (CAS) message by a computer on board the aircraft,
wherein the CAS message automatically indicates that measured data for a relevant variable of one of the sub-systems has an abnormal value and that an abnormal condition has been detected, and
wherein the step of storing further comprises:
storing the CAS message and the measured data for each of the relevant parameters that are associated with that CAS message in a parameter information corresponding to that CAS message, wherein the measured data for each of the plurality of relevant parameters comprises a data stream for that particular relevant parameter that is measured for a particular duration of time.

19. An aircraft having a plurality of sub-systems, the aircraft comprising:
a first processor that is configured to monitor the sub-systems to detect a trigger event during flight of the aircraft and to measure, in response to detecting the trigger event, data for a plurality of relevant parameters;
a first memory configured to store measured data for each of the relevant parameters in a parameter file; and
a transmitter operable to transmit the parameter file from the aircraft over a wireless communication link.

20. A ground support network configured to receive a parameter file and to identify one or more sources that are causing an abnormal condition, the ground support network comprising:
a second memory configured to store a plurality of aircraft health and trend monitoring (AHTM) program modules; and
a second processor configured to execute a selected one of the AHTM program modules and process measured data for a plurality of the relevant parameters to identify one or more sources that are causing the abnormal condition.
